(19) United States
(12) Patent Application Publication
(10) Pub. No.: US 2009/0164929 A1
(43) Pub. Date: Jun. 25, 2009

(54) Customizing Search Results

(75) Inventors: Shuo Chen, Kenmore, WA (US); Emre M. Kiciman, Seattle, WA (US); Yi-Min Wang, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/137,508

(22) Filed: Jun. 11, 2008

Related U.S. Application Data
(60) Provisional application No. 61/015,512, filed on Dec. 20, 2007.

(51) Int. Cl. G06F 3/048; G06F 7/06; G06F 17/30

(52) U.S. Cl. 715/769; 707/5; 707/E17.017

(57) ABSTRACT

A system customizes search results. In one implementation, an exemplary system personalizes search results based on recommendations from members of online social networks to which the user belongs, who have made similar search queries in the past. The system also enables the user to arrange, insert, and delete search result entries into a customized search results queue from across multiple search engines. The user's own customizations of the search results may be shared, in turn, as recommendations for other users who submit similar search queries and who are associated with the user through online social networks. The system may automatically provide personally relevant search results for a subjective query. In one implementation, the system also posts search results that contain explicit recommendations made by peers, posts the reputation of the peers, and appends links to channels for directly communicating with those peers who submitted the recommendations or with peers who are currently performing a similar search.

### RELATED APPLICATIONS

This application claims priority to U.S. Provisional Patent Application No. 61/015,512 to Chen et al., entitled, “System for Customizing Search Results,” filed Dec. 20, 2007 and incorporated herein by reference.

### BACKGROUND

Search engines are one of the most important tools that Internet users rely on. Popular search engines, such as LIVE.COM, GOOGLE.COM and YAHOO.COM, are powered by information retrieval, data mining, and machine learning algorithms. These conventional search engines return deterministic results. That is, any one of the above-listed search engines, as well as others presently utilized, is highly likely to return identical search results for a particular query simultaneously submitted by multiple users. That is, search engines are typically agnostic to the source of the query. Such objectivity is not undesirable, however, as it provides dependable and reproducible results.

Moreover, known search algorithms may also track user actions, such as click-counts, as input data for improving the search results. However, these user actions may only be employed in a limited manner for preventing malicious entities, such as web spammers, from corrupting search results for the general population of users.

### SUMMARY

Exemplary systems and methods for customizing search results are described. In one implementation, an exemplary system may enable personalization of search results based on recommendations from members of online social networks to which the user belongs. Further, an exemplary system may facilitate personally relevant search results for a subjective query. Further still, an exemplary system may enable the posting of search results that contain explicit recommendations made by peers, the posting of a reputation of the peers, and the appending of links to channels for directly communicating with those peers who submitted the recommendations or with peers who are currently performing a similar search.

This summary is provided to introduce the subject matter of customizing search results, which is further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram of an exemplary search results customization system.

FIG. 2 is a diagram of basic operations of the exemplary search results customization system.

FIG. 3 is a block diagram of an exemplary search results customization framework.

FIG. 4 is a diagram of discovery and creation of social connections for a given user.

FIG. 5 is a screenshot of an exemplary query-result page and user interface.

FIG. 6 is a screenshot of an exemplary query-result page and user interface for importing search results from a second search engine into search results from a first search engine.

FIG. 7 is a screenshot of an exemplary query-result page user interface with integrated social networking features.

FIG. 8 is a flow diagram of an exemplary method for customizing and personalizing search results.

### DETAILED DESCRIPTION

Overview

This disclosure describes systems and methods for customizing search results. “Customizing,” as used herein includes manual reorganization or “personalization” of search result queues as presented on the user's browser display; automatic adjustment of search results based on the user's own past adjustment preferences or learned preferences of similar users; and automatic personalization of search results based on shared feedback from the user's social networking connections. The feedback from social networks may include recommendations of friends and input from other users who share a similar interest or search query with the user. Social networking connections refer to the user's online associations with other people, online services, and communities that the user may knowingly or unwittingly belong to. Besides social networking connections, an exemplary system may use other criteria indicative of the user's status to modify or disambiguate search results, such as geographical location, known interests, and value of friends' input.

In one implementation, the exemplary system allows users to edit their personal search results lineup, including rearranging the order of a search results list, deleting entries, and adding entries, for example, adding uniform resource locators (URLs) from additional search result lists that have been returned by additional search engines. The exemplary system remembers such adjustments if they are indicative of a preference pattern, and not only remembers the adjustments but may share the adjustment with future users who submit a similar query.

In one implementation, the exemplary system also discovers the user's social networking connections or defines communities for the user based on the user's status and environment, in order to gain some prescience regarding the search results to be returned. On a practical level, the user's social connections may be used to filter not only the search results to be displayed but also the many ways that the search results may be prioritized and presented. Thus, the relevance of feedback to a search result may be established based on a degree of similarity between a member and the user. Further, the user's social connections may be further used to filter query suggestions, spelling corrections, and other user interface enhancements used by search engines.

The exemplary system may utilize a system of credits to establish reputations of various related friends and social communities. A given friend's feedback or input may be weighted according to their credit score or their reputation for establishing a prioritization of the search results. Thus, by an exemplary system, one credit score may be recorded to represent a user's general reputation, and one or more additional credit scores may be recorded to represent the same user's reputation within the scope of one or more specialized topics. Further, multiple sets of credit scores may be used to represent the user's reputation within the context of different communities.

The customized and personalized search results may therefore include recommendations and ratings from friends and peers (e.g., a search on “best restaurants” may return a restaurant name with a “highly recommended by Bob” result). Further, recommendations may include annotations by user (e.g., “highly recommended by Bob” may include the annotation, “Bob says, ‘check out the desserts’,”).

In at least one implementation, the exemplary system may test for online presence of those friends and peers whose feedback or recommendations appear in the search results. The system may append communication icons and links to each search result, so that the user may directly contact friends and peers from the same search result entries, for real-time instant messaging, email, etc.

Exemplary System

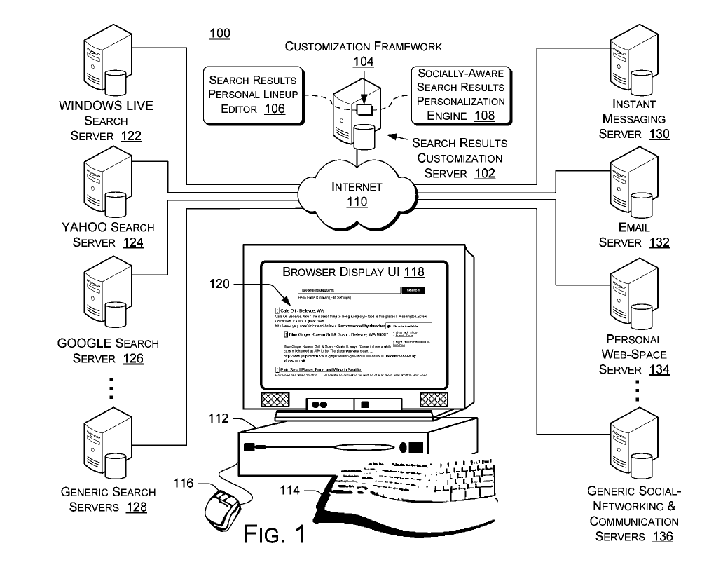

FIG. 1 shows an exemplary search results customization system 100 that is based on user adjustments and social-network-aware personalizations. In the exemplary system 100, a search results customization server 102 hosts and/or is communicatively coupled with a search results customization framework 104. In one implementation, the framework 104 includes a search results personal lineup editor 106 and a socially-aware search results personalization engine (“personalization engine”) 108.

The customization server 102, including the customization framework 104, is communicatively coupled with the Internet 110, and via the Internet 110 to users. Each user accesses the exemplary system 100 through a computing device 112, such as a desktop computer, notebook computer, mobile phone or other computing device that includes processor, memory, data storage, etc., and Internet 110 access. A typical user has input devices such as a display, keyboard 114, and mouse 116. The computing device 112 runs an Internet browser, which presents a browser display UI 118 for interacting with the search results customization server 102 and for presenting search results 120.

The search results customization server 102, by being in communication with the Internet 110, is also communicatively coupled with various conventional search engines hosted by services, such as a WINDOWS LIVE search server 122, a YAHOO search server 124, a GOOGLE search server 126, . . . , and other generic search servers 128. Likewise, the search results customization server 102, by being in communication with the Internet 110, is also communicatively coupled with various social networking services, such as an instant messaging server 130, an email server 132, a personal web-space server 134, . . . , and generic social-networking and communication servers 136.

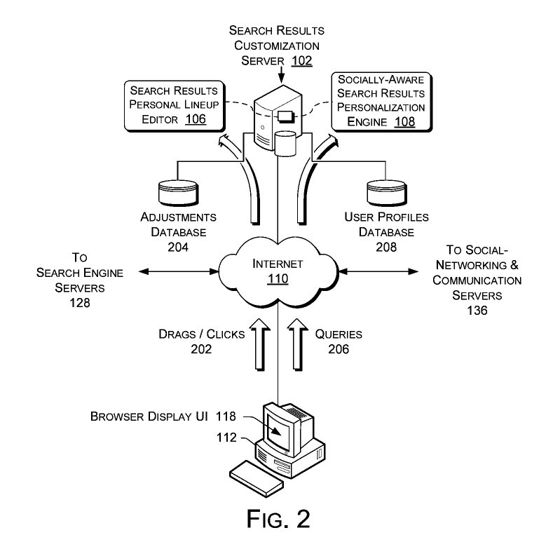

FIG. 2 shows some basic operations of the exemplary search results customization system 100 of FIG. 1. A user, presented with conventional search results, may choose to manually customize or annotate the search results via the keyboard 114, mouse 116, and other input devices at hand. That is, by interfacing with a browser displayer UI 118 using known means, the mouse dragging and clicking 202 are received at the customization server 102 and compiled by the search results personal lineup editor 106; and when useful to characterize the user's ongoing preferences, are stored in an adjustments database 204.

The user's search queries 206 are transferred to the search results customization server 102 and parsed by components of the socially-aware search results personalization engine 108. The personalization engine 108 is animated by a user profiles and community profiles (“user profiles”) database 208, in order to find: user preferences, each user's online communities, each user's social-networking connections, feedback and recommendations, as well as the user's individual friends and peers that have the same interests as the user. The user profiles database 208 not only informs the personalization engine 108, but is also modified and updated by the personalization engine 108. For example, recommendations made by each user may in some implementations become part of the user's profile, and relevant feedback and recommendations submitted by a user may raise the user's trustworthiness credit score or reputation in the user profiles database 208.

Exemplary Engines and Components

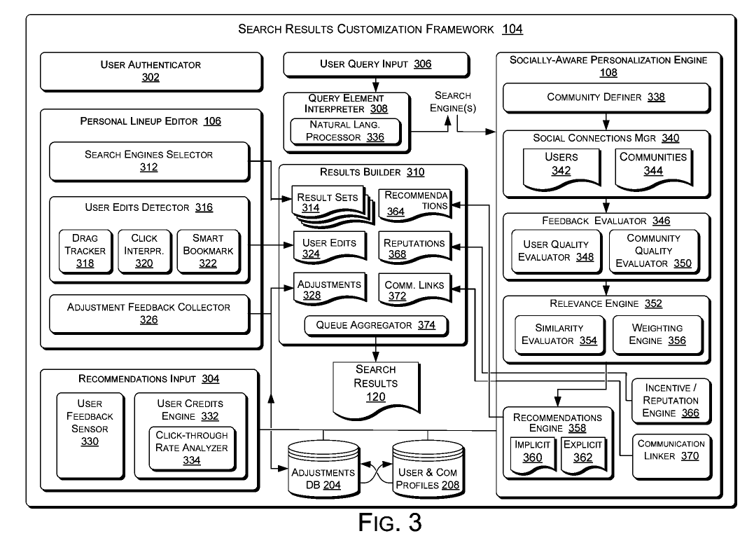

FIG. 3 shows one version of the exemplary search results customization framework 104 of FIGS. 1 and 2, in greater detail. The illustrated implementation is only one example configuration, for descriptive purposes. Many other arrangements of the components of an exemplary search results customization framework 104 are possible within the scope of the subject matter. Implementations of the exemplary search results customization framework 104 may be executed in various combinations of hardware and software.

A “parts list” of components of the exemplary customization framework 104 is presented first. Then, after a listing of the components, a detailed description of the operation of the exemplary customization framework 104 will be presented.

The exemplary search results customization framework 104 includes a user authenticator 302, the personal lineup editor 106 introduced above, a recommendations input 304; a user query input 306, a query element interpreter 308, a results builder 310, and the socially-aware search results personalization engine 108 introduced above. In general, the customization framework 104 uses the adjustments database 204, the user profiles database 208, and search results from search engines to produce customized and personalized search results 120.

The personal lineup editor 106 may further include a search engines selector 312 that may select multiple search engines in order to leverage multiple search result sets 314 when building the search results 120. The personal lineup editor 106 may further include a user edits detector 316, including a mouse dragging tracker 318, a mouse click interpreter 320, and a smart bookmarker 322 for manipulating URLs into the search results 120. When other user inputs are utilized instead of keyboard 114 and mouse 116, the user edits detector 316 tracks these other user interfaces. The user edits detector 316 provides user selections and edits 324 to the results builder 310. An adjustment feedback collector 326 compiles the user search queue adjustments 328 for building current search results, and may store the adjustments 328 in the adjustments database 204.

The recommendations input 304 may include a user feedback sensor 330 to collect both implicit and explicit recommendations made by the user, e.g., by following user behaviors and choices when the user selects a product or service, and by collecting explicit recommendations, such as “I rate this movie a 10”. The user feedback sensor 330 is thus similar in some respects to the adjustment feedback collector 326, which derives adjustment feedback from user edits. A user credits engine 332 may build a user's reputation or credit rating based on feedback to the user's recommendations, including for example, that captured by a click-through rate analyzer 334.

When the user submits a query, which is received via the user query input 306, the query element interpreter 308 may include a natural language processor 336 to interpret the query, especially subjective aspects of the query.

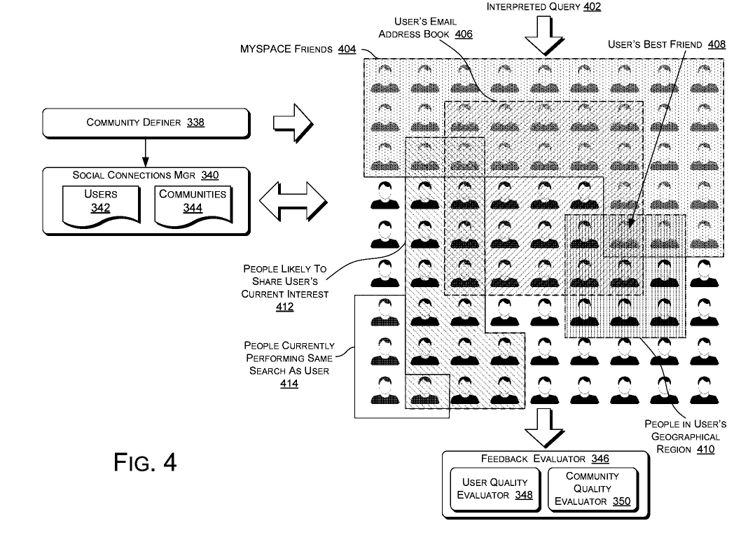

The personalization engine 108 may further include a community definer 338 (described in greater detail with respect to FIG. 4) to discover or define a group, community, or social network of users providing feedback relevant to the user's current query.

The personalization engine 108 further includes a social connections manager 340 to manage feedback relevant to the current query from users 342 and communities 344 defined or discovered by the community definer 338. A feedback evaluator 346 correspondingly includes a user quality evaluator 348 and a community quality evaluator 350.

A relevance engine 352 includes a similarity evaluator 354 to compare the user or community providing feedback with known attributes of the current user. A weighting engine 356 then assigns an importance or a weight to the current feedback based on the similarity.

A recommendations engine 358 finalizes both implicit feedback 360 (e.g., “Your friends clicked here!”) and explicit feedback 362 (e.g., “Shuo recommended this restaurant!”) to be integrated as queue-forming directives and as explicit recommendations 364, respectively, when building search results 120. An incentive & reputation engine 366 may post reputation information 368 to be associated with recommendations 364 and displayed in the search results 120. A communication linker 370 associates communications channels with specific users 342 and communities 344 and may post multiple communication links 372 (i.e., links to communication channels) with each qualifying entry in the search results. The communications channels may include, for example, a clickable instant messaging (IM) icon for online peers who have made a recommendation that appears in the search results 120, or email and website links for offline friends and peers who have provided feedback that appears in the search results 120.

In the results builder 310, a queue aggregator 374 begins with raw search result sets 314 from one or more search engines, and applies to the search results the current user's selections and manual edits 324, the adjustments 328 implied by the user's edits 324 and/or derived from the adjustments database 204, the recommendations 364 from the personalization engine 108, the reputations 368 and incentives, and the communication links 372. The queue aggregator 374 has logic for assigning a priority to each of the various elements accessed by the results builder 310 when forming a queue of search results, i.e, a priority for when these elements conflict.

User Experiences

The exemplary search results customization framework 104 improves search relevance through social context and also transforms searches into a way to connect people together. Thus in one implementation, the customization framework 104 combines queue customization (e.g., drag-and-drop re-ranking, interest-based re-ranking), sharing through social networking (i.e., friends influence one another's search results), and communication (i.e., the search page may incorporate presence information for friends or people with shared interests). Adding social networking and communication capabilities into the search experience has many benefits, providing improved context for searches, as well as aligning a user's search experience with the user's real-time context.

From a relevance point-of-view, the personalization engine 108 explicitly takes into account social networking contexts—such as friends' interests, click histories, and other navigation behaviors. These provide extra context to create more relevant results, i.e., via the recommendations 364, via better disambiguation of query terms, via more relevant related queries, etc. The personalization engine 108 may implicitly use social networking contexts to re-rank search results 120, or may mark search results 120 with a recommendation and incentives, such as the tag, “Your friends liked this link!”

The personal lineup editor 106 enables explicit re-ranking of the search results 120. When the re-ranked search results 120 are stored in the adjustments database 204, the re-ranked results may be shared with friends. This allows the customization framework 104 to answer subjective queries that are poorly served by current conventional search engines, such as recommendations for restaurants, books, movies, etc. The personal lineup editor 106 also allows users to re-rank results for their own personal reasons (e.g., to impart a sense of self-importance during searching, to create shortcuts to often-used sites, etc.) and thereby also gain immediate benefit.

In one implementation the personalization engine 108 includes the communication linker 370 for adding messaging capabilities to searches. This allows users to connect with their friends and others interested in similar topics. In one scenario, a user may see that a recommender is online and start a chat to ask for more information. In other scenario, users who are searching on the same topics at the same time may see chat links to each other (“Do you want to chat with other people searching for British Columbia resorts?”)

User Experience Examples

The following examples demonstrate functionality and user experience of the exemplary search results customization framework 104.

1. Tom likes good restaurants. To share his expertise with his friends he uses the search engines selector 312 to select a search engine that has been associated with the customization framework 104, queries for “favorite restaurants,” and then uses the personal lineup editor 106 to customize the search result set 314 to show his “top 10” list of favorite restaurants around Seattle. Later, Tom's friend, Jerry is looking for a place to eat and searches for “restaurants.” Among his search results, Jerry sees a “Palace Kitchen” entry and an associated recommendation 364 in the form of the note, “Tom recommends this”. Jerry trusts Tom's recommendation and clicks through to the restaurant web site to make reservations. The click-through rate analyzer 334 signals the user credits engine 332 to increase Tom's reputation.

2. Jerry is now ready to go to dinner. Before he leaves his computer, he notices Tom's presence icon placed by the communication linker 370 next to Tom's recommendation showing that Tom is online. He clicks the icon and sends Tom a message with a question “Hi Tom, I saw your recommendation for Palace Kitchen. I'm about to go there. What did you like on the menu?” Tom is happy to hear that Jerry is going to one of his favorite restaurants, and they have a brief conversation.

3. Bill is watching a presidential debate and becomes curious about the candidates' positions on an issue important to him, retirement benefits. Bill uses the search engines selector 312 to select a search engine that has been associated with the customization framework 104 and queries for “[candidate name] retirement benefits policy”. The search engine returns an impressive set of results 314, but the communication linker 370 has also placed a link “Would you like to chat with other people interested in [candidate name] and retirement benefits?” Bill clicks yes, and opens up a chat session with several other people who are currently watching the debate and asking themselves the same questions about candidate's positions.

4. Lonely Gus does not have friends, but still uses the re-ranking capability of the personal lineup editor 106 to build shortcuts to his favorite URLs and save items when he is doing research on the Internet 110.

5. Friendly Frank has many friends but has never used the search results customization framework 104 before. The first time he uses a search engine associated with the customization framework 104, he is surprised to find how well customized the search engine is for his interests. The search results 120 seem to already “know” and include what Frank likes (acronyms are expanded correctly, his friends homepages are in the top results, etc). Because Frank's friends also use the customization framework 104, Frank receives the benefit of their histories, re-rankings, etc.

The exemplary system 100 encourages users to actively contribute their knowledge responsibly to benefit other users, and also allows better sharing of the implicit knowledge gained by analysis of user actions such as click-counts.

In the personal lineup editor 106, a user may find that certain adjustments 328 or local files are useful for his/her personal use. The user may choose to keep these adjustments 328 in his/her personalized search result page.

Each user has his/her own domain knowledge, and may have opinions about certain search results that are not appropriate. The personal lineup editor 106 allows community collaborative searches so that the user may intuitively modify search results 120. Then friends and communities may share in the improved results.

Conventional search engines have difficulty directly answering subjective queries. For example, given a query such as “best restaurants,” conventional search engines often provide links to sites with lists of restaurants, not links directly to the web sites of the best restaurants. One of the challenges to providing this subjective functionality is that the definition of “best” restaurant is not objective, and generally does not depend on the quality or link popularity of the restaurant's website.

By soliciting users to generate their own personalized “top 10” search results for such subjective queries (“best . . . ”, “favorite . . . ”), merging and sharing these results across social networks, the exemplary personalization engine 108 may capture the shared preferences of groups of friends and allow the user's search engine to answer a new category of queries.

The socially-aware personalization engine 108 may collect important and worthy feedback to improve general search engines. Conventional general-purpose search engines allow users to send feedback in order to improve quality. The feedback is essentially in text format, and needs to be read by a human. When using the exemplary customization server 104, however, most types of important feedback, such as missing URLs, inappropriateness of ranking, diversity issues, and freshness issues may be sent using intuitive mouse actions. In one implementation that employs the user credits engine 332, the personalization engine 108 may easily select feedback from high-credit users to send to conventional general-purpose search engines. These feedbacks may be processed in higher priority than regular feedbacks.

Operation of the Exemplary Customization Framework

In one implementation, when the user's browser issues a query to the exemplary customization framework 104 at the server 102, the server 102 obtains a query-result page, e.g., from a search engine at the LIVE search server (http://search.live.com). When the user avails of the search engines selector 312, the exemplary customization framework 104 also obtains query result pages from other search engines, such as GOOGLE search (http://www.google.com) and YAHOO search (http://search.yahoo.com).

Before the query-result page is returned to the browser, the exemplary customization framework 104 may obtain the user's profile data from the user profiles database 208 and adjustment history data of the query from the adjustments database 204. When the page is rendered in the browser, a JavaScript procedure, for instance, displays user profile data and applies the adjustments by dynamically changing the HTML page. When the user drags or clicks on URLs, the adjustment feedback collector 326 receives messages describing these actions in order to update the databases 204 and/or 208.

There are multiple alternative implementations of the exemplary customization framework 104. One implementation moves the exemplary customization server functionalities (including automatically adjusting search results) completely into a web service, such that personalized search results are returned directly to the user. This implementation also incorporates the social networking and sharing functionality of the socially-aware personalization engine 108.

Table 1, below, shows example database schemas of one implementation. “User_profile” is a data structure to store a user's basic information, including user name, user ID and credit score, for example. “User_raw_action” is a data structure to store the details of dragging actions, including re-ranking in the primary search results 120 and importing auxiliary results from other search engines. The data structure “Adjustment” is derived from “User_raw_action.” Every entry in the Adjustment data structure indicates how each URL in a query page is affected by a given user action, e.g., being moved up or down by n positions. At least one alternative implementation of the Adjustment data structure may record adjustments to the URL's importance, or may record the absolute position at which the user placed the URL on the search results page. The data structure “Click” is the click log.

TABLE 1
Example Database Schemas

Create Table User_Profile {

| | |
|---|---|
| User_name [nvarchar] (50) not null, | //user name |
| uid [nvarchar] (max) not null, | //user ID |

| | |
|---|---|
| score [int] | //user's credit score |
| } | |

Create table User_raw_action {

| | |
|---|---|
| Query_term [nvarchar] (max) not null, | //query term |

```
  uid [nvarchar] (max) not null, //which user makes the adjustment
  URL [nvarchar] (max) not null, //URL being dragged
  Position [int],  //the ranking position where the URL is dropped off
  titleOfAdded [nvarchar] (max) //in the scenario of importing auxiliary
```

//results, this field stores the title
//of the URL being imported into the primary
//result frame.

ts [nvarchar] (50) not null //time stamp of the action
}
Create table adjustment {

| | |
|---|---|
| Query_term [nvarchar] (max) not null, | // query term |

```
  uid [nvarchar] (max) not null,  //which user makes the adjustment
  URL [nvarchar] (max) not null,  //URL being dragged
  Offset [int], //the URL is moved up by n positions (−n)
        //or moved down by n positions (+n)
  ts [nvarchar] (50) not null  //time stamp of the action
}
Create table click {
```

| | |
|---|---|
| Query_term [nvarchar] (max) not null, | // query term |

```
  uid [nvarchar] (max) not null,  //which user clicks
  URL [nvarchar] (max) not null,  //URL being clicked
  ts [nvarchar] (50) not null //time stamp of the action
}
```

In one implementation, the customization framework 104 employs a user authenticator 302 to verify users, while in other implementations the customization framework 104 is public and transparent to users. The latter implementation may be utilized when users remain anonymous, that is, their feedback and recommendations are not attributable to them personally. Thus, the user authenticator 302 may be used when users wish to keep their identities secure except among their own social connections.

While conventional search engines make only limited use of end-user feedback (e.g., by analyzing click counts), a user of the exemplary customization framework 104 may make contributions by explicitly allowing the adjustment feedback collector 326 to send “result adjustment feedbacks” to the exemplary customization server 102 and the adjustments database 204. The dragging tracker 318, click interpreter 320, and smart bookmarker 322 may collect feedback, which may consist of mouse dragging & dropping on the search results page, or insertion of new URLs via the smart bookmarker 322. The exemplary customization framework 104 may immediately utilize the user's explicit feedback to personalize the user's search results 120.

In addition to allowing users to personalize their own search results 120 through the personal lineup editor 106, the exemplary customization framework 104 allows users to share their implicit recommendations 364 with friends and communities. For example, if a user named Bob ranks his own homepage as the #1 search result 120 for a search on “Bob”, then Bob's friends will also see his homepage ranked highly when they search for Bob. The general user population, however, will not see this change.

To determine the social network and communities of a user, the community definer 338 of the personalization engine 108 may integrate with one or more existing data sources, such as WINDOWS LIVE MESSENGER, HOTMAIL, SPACES, etc. Each user may be a member of multiple distinct social networking graphs (i.e., relationships culled from different sources). In addition, the user may be a member of one or more implicitly or explicitly defined communities, such as a geographically defined community (e.g., people living in Seattle, Wash.) or interest-based community (e.g., photography enthusiasts).

FIG. 4 shows discovery and/or creation of social connections for a given user. Once a group is defined by the community definer 338, the social connections manager 340 may track the one or more social communities 344 and the users 342 within each community via the user profiles database 208 and the adjustments database 204.

FIG. 4 depicts action on a query that has been interpreted by the query element interpreter 308 or the natural language processor 336. The interpreted query 402 is “submitted” to the users 342 and communities 344, which in one implementation means that the content of the query is not only submitted to one or more conventional search engines to produce result sets 314, but is also compared to the data structures or database schemas in the user profiles database 208 and the adjustments database 204.

In one implementation, the natural language processor 336 may modify not only a specific query, but also related queries. For example, re-ranking the results of a query for “best restaurants” may also result in automatic re-ranking of the search results for “good restaurants.”

In one implementation, the social connections manager 340 may consult web log data to obtain real time feedback about search behavior of a defined group. FIG. 4 shows the user's MYSPACE friends 404, contacts in the user's email address book 406, the user's best friend 408, people in the user's geographical region 410, people likely to share the user's current interest 412, and people currently performing the same search as the user 414. To determine feedback for the user from people currently performing the same search 414, the community definer 338 consults web log data to ascertain a group 414 currently submitting search queries that are similar to the user's query within a logical radius, i.e., the search terms do not need to be identical, but the meaning of the searches are similar. The social connections manager 340 then consults web log data to determine click-through patterns and navigation trajectories of the users in the group 414. Such a query may result in a recommendation 364, such as “Users making a similar search also liked this (website, product, service, destination, etc.).”

The social connections manager 340 of the personalization engine 108 may facilitate sharing of both explicit re-ranking feedback 362 as well as other sources of personalization across multiple social network groups or online communities that the user belongs to.

In one implementation, the feedback evaluator 346 automatically measures the quality of a user's feedback in different contexts. First, the user quality evaluator 348 may create a “general-purpose” score that evaluates the overall quality of the feedback provided by the user and its usefulness to a broad population of users. If a user's suggestions improve the quality of results provided to others (as measured via the click-through rate analyzer 334 or other means), the user receives a credit.

As a user's credits increase, the user's suggestions may be allowed to influence a wider audience. Likewise, the community quality evaluator 350 may create a quality score for different online social networking services or communities. Communities may have an absolute credit score or a relative credit score with respect to other groups. For example, a teen online community may not provide very high quality feedback for non-teen communities, but may provide very interesting and reliable feedback for other teen communities. Likewise, some social networking communities may be too large and heterogeneous to ever merit a quality score for reliable feedback as a community. Such communities maintain a low community credit score, which means feedback arising from a user in the community is given low weight compared with feedback from other sources, if the user submitting the feedback has no other credentials (other community memberships).

The relevance engine 352 includes the similarity evaluator 354 to track a “similarity” via the user profiles database 208 between a user and each of his or her friends that indicates how useful the friend's feedback has been for the user. The weighting engine 356 then weights the feedback for eventual ranking at the results builder 310. The personalization engine 108 may also perform topic-based personalization (your friends are interested in computers, maybe you are too . . . )

As mentioned, the quality of feedback or the improvement provided by feedback may be measured in one of many different ways, such as by the click-through rate analyzer 334 measuring an improvement in click-through rate.

To encourage users to provide feedback and personalize their search engine results, the exemplary personalization engine 108 includes an incentive/social-reputation engine 366 to acknowledge users' contributions to their friends (e.g., “Thanks to Bob for suggesting this site!”) Alternatively, users' credit scores may serve as their reputation scores.

In variations, the exemplary customization framework 104 may integrate an Instant Messenger service for presence and communication support. The customization framework may also incorporate third party services and websites, e.g., FACEBOOK, for information for both social networking relationships and also for priming favorites and interest lists in the user profiles database 208, based on data already in the profiles of the third-party services. The exemplary customization framework 104 may also integrate with current search infrastructure: e.g., use a search service's writable store, session management, or support of whole pages, etc.

Exemplary User Interfaces (UIs)

Exemplary browser display UIs 118 associated with the customization framework 104 may be very similar to those of conventional general-purpose search engines, but may have, for example, additional or different visual areas or panes.

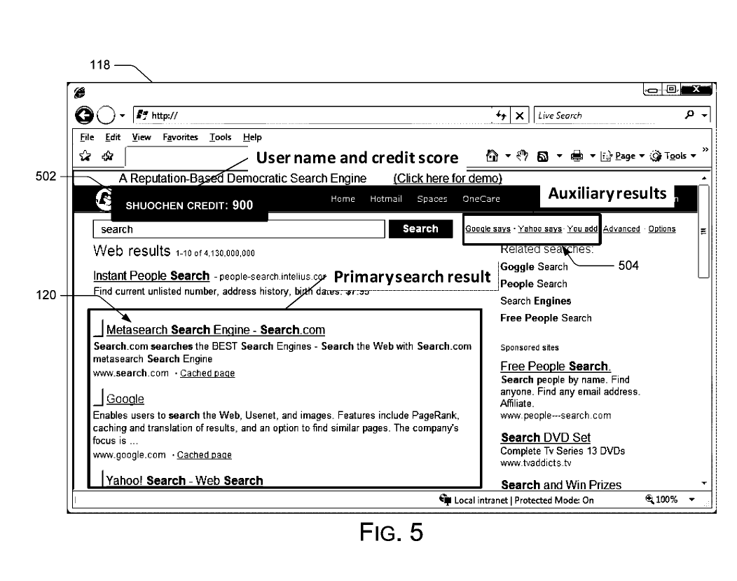

FIG. 5 shows an exemplary browser display UI 118. In one implementation, the user authenticator 302 verifies each user in order for the user to have re-ranking capability with the personal lineup editor 106. A user name area 502 shows the user's reputation via a credit score earned by submitting past helpful feedback. Initial search results 120 are displayed in a primary search result area. Although the appearance of the listed search result items are similar to those from a conventional general-purpose search engine, the personal lineup editor 106 associated with the exemplary UI 118 allows users to drag-and-drop the individual search result entries and/or URLs in order to re-rank them, or delete and insert search results from another search engine.

The search engines selector 312 (FIG. 3) is manifested through an auxiliary-results visual area 504 (FIG. 5) containing a set of links to allow opening other search engine results and/or to allow manually adding results from the other search engines to the initial search results 120.

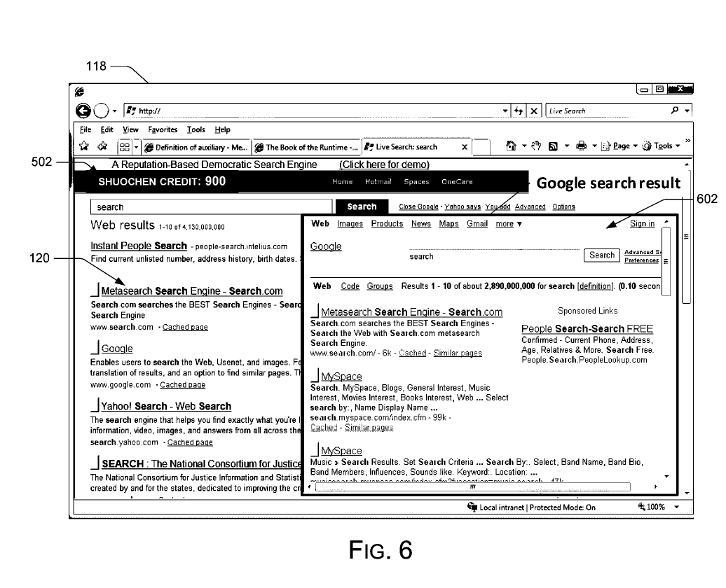

FIG. 6 shows an example state of the browser display UI 118 when an additional search engine link, such as a “GOOGLE says” link, is clicked (i.e., when GOOGLE was not the initially selected search engine). In this scenario, the visual page opens an inline frame 602 to host the additional search result set(s) 314, such as the GOOGLE results page for the same query. Then, the user may drag and drop, e.g., GOOGLE items, into the primary search results 120. The personal lineup editor 106 collects the user's editing actions via the user edits detector 316 and stores relevant adjustments in the adjustments database 204. Similarly, if the user clicks a “YAHOO says” link in the auxiliary results area 504 (FIG. 5), then YAHOO search result items may be inserted into the primary search results 120. In one implementation, a “You add” link in the auxiliary results area 504 allows the user to manually add keyed-in or pasted-in URLs.

Alternatively, in at least one other implementation, auxiliary results 504 may be obtained from executing a different query against the same or different search engine. Then, the user may drag and drop results from this different query into the results of the primary search 120.

In one implementation the exemplary customization framework 104 may also accept suggestions through mechanisms external to the search results 120; e.g., the smart bookmarker 322 may manifest itself in the browser display UI 118 for adding a currently viewed page to the search results 120.

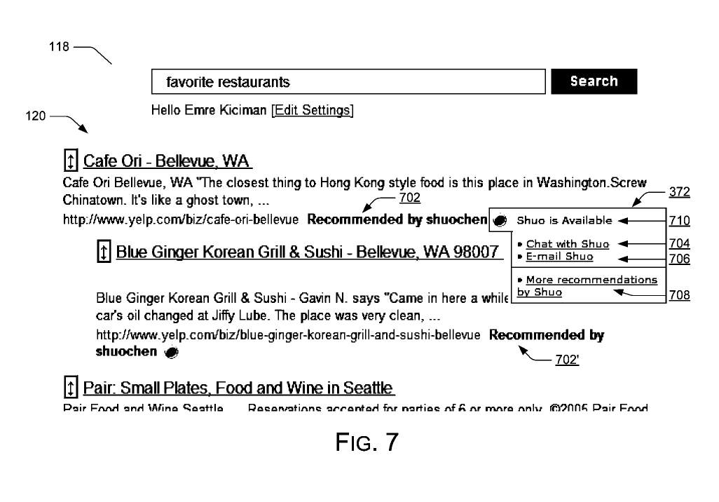

FIG. 7 shows another exemplary browser display UI 118, in which search results 120 include implicit and explicit recommendations 364, including automatic prioritization of the search results 120 based on peer recommendations 702 and 702′ (returned by the personalization engine 108), a display of the recommendations 702 and 702′ themselves in text form, and associated communication links 372 of the peer. The communication links include a real time chat link 704 for contacting the peer in real time, an email link 706 to the peer, and a link to further recommendations 708 made by the same peer. In one implementation, the communication linker 370 determines the degree of presence of the peer, i.e., the degree to which the recommending peer is available, which may be displayed as an availability indicator 710.

Exemplary Methods

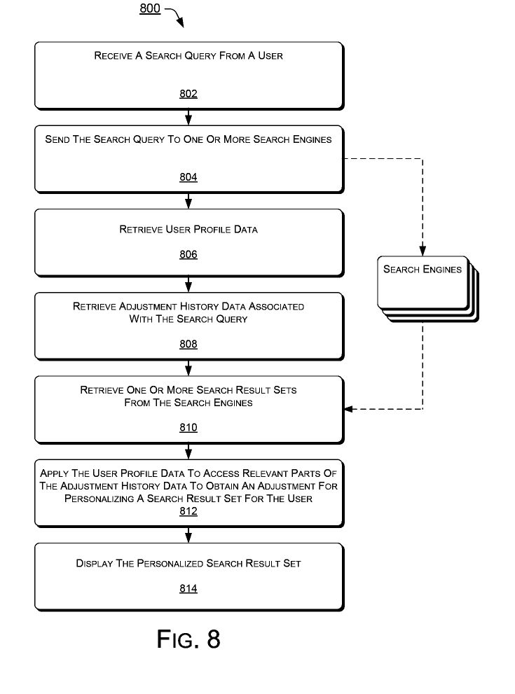

FIG. 8 shows an exemplary method 800 of customizing and personalizing search results. In the flow diagram, the operations are summarized in individual blocks. The exemplary method 800 may be performed by combinations of hardware, software, firmware, etc., for example, by components of the exemplary search results customization framework 104.

At block 802, a search query is received from a user. Conventionally, each search query stands by itself and is deterministic. That is, the same combination and order of search terms yields identical search results regardless of the identity of the user submitting the query. In the exemplary method 800, however, each archetypal search query that may represent multiple similar search queries has a database record of adjustment history data provided by users who have made the query and have adjusted the conventional results in some manner to suit their needs. Hence, archetypes for each search query carry a record of improvements made to corresponding search results by different types of users.

Various processing techniques may be used to create the bridge between similar search queries so that minor differences in search queries do not prevent each query from receiving the benefit of adjustments and recommendations made by past users. Such processing techniques may include natural language processing techniques to arrive at a hypothetical archetypal query that covers multiple similar queries (so that a query for “good restaurants” would merit the same personalized search results as a query for “best restaurants”). Alternative processing techniques may rely on analysis of query-click logs or comparison of search result sets to discover related queries.

At block 804, the search query is sent to a search engine. In one implementation, the search query may be sent to multiple conventional search engines, selectable by a user. The exemplary method 800 may be viewed as separate from the techniques leveraged by the search engines returning the search results or may be also be integrated with the search techniques, thereby providing an innovative search engine.

At block 806, user profile data of the user is retrieved. The user profile data may include attribute and interests of the user, but more importantly includes the user's online memberships and social connections, and may therefore be used to find similarly situated users who may have previously submitted recommendations regarding the search results corresponding to the search query at hand.

At block 808, adjustment history data associated with the search query is retrieved. The retrieved adjustment data may include feedback regarding the search query, submitted by a member of an online social network that the user belongs to. Depending on the similarity or degree of friendship between the user and the member, the member's previous feedback regarding the query may be worth presenting with high priority in the search results. Hence, the conventional search results for the query will be modified with this relevant feedback from the related member.

At block 810, a search result set is received from the search engine. Reception of the search result set from one or more conventional search engines merely complements the step of sending the search query at block 804.

At block 812, the user profile data is applied to access relevant parts of the adjustment history data in order to obtain an adjustment for personalizing the search result set for the user. The exemplary method 800 aggregates user profile data, adjustment history data related to the particular query, and the returned search results in order to provide a customized lineup of conventional search results possibly mixed with personalized recommendations from online members that have some similarity to the user.

Feedback relevant to the search query at hand may be evaluated for quality and relevance and subsequently weighted to determine how the feedback should rank in prioritized search results.

At block 814, the personalized search result set is displayed for the user. In one implementation, the method 800 also displays contents of explicit recommendations in the search results as well as recognition of the member providing the recommendation. Likewise, the user's reputation may be displayed with the recommendation. Further, links to communication channels for contacting the member may also be displayed. In one implementation, the method 800 determines an online presence of the member, and displays a link for immediately chatting with the member in real time, to address questions about the recommendation.

The method may also include extending a user interface for displaying multiple search result sets from multiple search engines so that the user may edit and arrange each search result set by dragging search result entries between search result sets. These edits and adjustments may be stored as recommendations and feedback for other future users making the same query. When the user's adjustments are found to be useful for others, the user's reputation is incremented.

Conclusion

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
receiving a search query from a user;
retrieving user profile data of the user;
applying the user profile data and the search query to access relevant parts of adjustment history data;
applying the relevant parts of the adjustment history data to results of the search query; and
displaying a personalized search result set for the user.

2. The method as recited in claim 1, wherein the adjustment history data includes feedback regarding the search query provided by at least one member of an online social network to which the user belongs.

3. The method as recited in claim 2, wherein the feedback from the member of the online social network determines an adjustment for personalizing the results of the search query, wherein further the adjustment includes an additional entry in the results of the search query, deleting an entry, or modifying an order of the entries in the results of the search query.

4. The method as recited in claim 2, wherein the feedback from the member of the online social network includes a recommendation, wherein further the recommendation is displayed in the results of the search query, and an identity of the member is optionally displayed with the recommendation.

5. The method as recited in claim 4, further comprising:
appending one or more communication links to the recommendation that include computer-executable choices for contacting the member who made the recommendation,
wherein the communication links include one of a chat link for contacting the member in real time, an email link to the member, or a link to further recommendations made by the same member.

6. The method as recited in claim 5, further comprising displaying a reputation of the recommending member.

7. The method as recited in claim 2, further comprising:
evaluating a quality of feedbacks from multiple members of one or more social networks to which the user belongs;
establishing a relevance of each feedback based on a degree of similarity between the member and the user; and
weighting each feedback according to the relevance for prioritization of the recommended content within the search result set.

8. The method as recited in claim 2, wherein the member has a relevance to the user via one of a common membership in a social networking community, a presence in the user's geographical region, an inclusion in an electronic address book of the user, a profiled common interest held by the member and the user, or a current common search query being executed by the member and the user.

9. The method as recited in claim 1, further comprising defining a social network of the user for obtaining feedback based on a demographic of the user, a profiled interest of the user, or a content of the search query.

10. The method as recited in claim 1, further comprising:
extending a user interface for displaying multiple search result sets from multiple search engines,
wherein the user interface enables the user to edit and arrange each of the results of the search query, the editing and arranging including dragging entries from a first displayed set of the results of the search query into the prioritized lineup of a second displayed set of the results of the search query, and allowing the user to delete and manually add various results of the search query in the prioritized lineup.

11. The method as recited in claim 1, further comprising extending a user interface for displaying multiple search result sets from multiple search queries, wherein the user interface enables the user to edit and arrange each search result set, the editing and arranging including dragging search result entries from a first displayed search result set into the prioritized lineup of a second search result set and allowing the user to delete and manually add search result entries in the prioritized lineup.

12. The method as recited in claim 10, further comprising:
tracking the user's editing and arranging associated with the search query;
storing the editing and arranging as a recommendation in the adjustment history data associated with the search query;
measuring a utilization of the recommendation by other users performing the search query; and
incrementing a credit reputation of the user based on the degree of utilization.

13. The method as recited in claim 1, further comprising:
automatically adjusting results of related search queries based on the results of the search query by applying processing techniques to modify the related search queries.

14. A system, comprising:
a user interface; and
an engine communicatively coupled with the user interface to customize a user's search results and search results lineup based on feedback from a member of an online community to which the user belongs.

15. The system as recited in claim 14, wherein the online community comprises one of a social network, a population within a geographical region, users represented in an electronic address book of the user, users who share a common interest with the user, or users currently performing a similar search as the user.

16. The system as recited in claim 14:
wherein the engine allows the user to re-order the search results, insert entries from an additional source into the search results, and remove entries from the search results;
wherein the engine stores the reordering, the inserting, and the removing as adjustment data associated with the query; and
wherein the engine shares the adjustment data with online users that have a relationship to the user.

17. The system as recited in claim 14, wherein the engine uses the feedback to provide personalized search results for subjective search queries.

18. The system as recited in claim 14, wherein the engine displays in the search results a recommendation based on the feedback;
wherein the engine posts a reputation of the member associated with the recommendation;
wherein the engine displays links to communication channels for contacting the member associated with the recommendation; and
wherein the engine displays links to communication channels for contacting users searching on a same topic as the user.

19. A system, comprising:
means for customizing a user's search results based on a recommendation from a member of an online social network to which the user belongs; and
means for enabling the user to arrange, insert, and delete search result entries into a customized search results queue from across multiple search engines.

20. The system as recited in claim 19, further comprising means for sharing the customized search results queue with a member of the online social network when the member performs a search query.
